(19) United States
(12) Patent Application Publication
(10) Pub. No.: US 2007/0241712 A1
(43) Pub. Date: Oct. 18, 2007

(54) Method and apparatus for digital control of a motor

(75) Inventors: Patrick Henry Dwyer, Penn Valley, CA (US); Gordon R. Southam, Grass Valley, CA (US)

Correspondence Address: AIM CONTROLS INC., P. O. BOX 1685, PENN VALLEY, CA, 95946, US

(73) Assignee: Aim Controls, Inc.

(21) Appl. No.: 11/406,195

(22) Filed: Apr. 17, 2006

(51) Int. Cl. G05B 19/10

(52) U.S. Cl. 318/567

(57) ABSTRACT

A method and apparatus for the control of electric motors comprised of: (1) a digital circuit for receiving the desired value of position, velocity, acceleration, or rate of change of acceleration for the motor; (2) a digital circuit to determine the actual position, velocity, acceleration, or rate of change of acceleration for the motor; (3) a digital circuit to determine the difference between the desired and the actual position, velocity, acceleration, and rate of change of acceleration for the motor; (4) a digital circuit that generates an error correction value based upon PID control methods; and (5) a digital circuit for generating drive signals for the motor that correct for any difference between the specified value and the measured value of position, velocity, acceleration and rate of change of acceleration for the motor. Further, the invention has a digital auto tuning capability to optimize the accuracy of the position, velocity, acceleration, or rate of change of acceleration operations for a particular motor so that the size of future error correction values needed for adjusting motor performance is minimized.

### 1. FIELD OF THE INVENTION

This invention pertains to the control of motors, and in particular to the control of electric motors.

### 2. DESCRIPTION OF THE BACKGROUND ART

There are a variety of “electronic” control systems that have been developed for motors that are commonly referred to as motor or motion controllers. They can be divided into two kinds: analog based systems and digital based systems. However, it is common to intermix analog and digital circuits in varying degrees in most such motor controllers. The primary purpose of these devices is to control the position, velocity and/or acceleration of the motor. Simpler motor controllers perform only velocity (speed) control, while more complex motion controllers enable control of all three parameters. The digital based systems employ microprocessors and software to perform the control functions, including in more complex motion controllers what is well known in the field as “PID” control. [PID stands for the Proportional error, the Integral of the proportional error, and the Derivative of the proportional error.] The digital based systems also vary from simple circuits that only control speed to complex circuit systems that control position, velocity and acceleration and implement PID control over the motor.

The following is a description of a typical example of the present digital based art in the field.

First, there is a microprocessor and related computer circuits (depending upon the complexity of the particular motor controller) such as memory circuits, disk drives, displays and screens, communication ports, and keyboards or keypads.

Second, there is a software operating system that is responsible for managing all of the digital and/or analog circuitry. These management functions include issuing commands to obtain the motor position from an encoder, set the motor to a desired velocity, change the acceleration of the motor, stop the motor at a particular point in time or at a particular location (based upon the encoder), and to compare the motor's actual position with the assumed (or projected) position.

Third, there is an electronic feedback circuit that runs from an encoder mounted on the end of the motor or on a shaft that the motor turns (typically of an optical type, but the encoder can be resistive, capacitive, magnetic, or mechanical) to a decoder circuit and then to a comparator circuit that compares the value obtained from the position encoder against the position value calculated by the software operating system. The feedback system is often an analog based circuit, together with an analog to digital converter used to convert the feedback signal to digital number useable by the microprocessor.

Fourth, the microprocessor circuit and software operating system performs a PID calculation based upon the desired position (and speed) set by the input control command and the actual position (and speed) as determined by the encoder feedback loop. This PID calculation is often done by means of software computation. The software computation is often replaced by analog circuits that employ operational amplifiers and filters that perform the PID functions. A variety of analog filters are also often employed to solve various problems in the software's PID loop calculation that arise from such as factors as noise, motor operating limits, and the gain value given to various PID loop values.

Fifth, there may be a digital to analog converter circuit that takes digital input signals (typically in the form of 16 bit position values) and converts them to analog voltages for use as the analog control signals for the motor driver circuit.

The following is a description of a typical example of the present analog based art in the field.

First, there is an analog voltage or current input circuit that translates the input voltage or current into a motor velocity. In simple analog motor controllers, the input voltage level controls the motor speed, usually with a linear correlation between voltage and velocity. The input voltage is used to directly control a power amplifier circuit that sends the commutation signals to the motor.

Second, in analog motion controllers that control position and acceleration, as well as velocity, there will be a feedback circuit that runs from an encoder mounted on the end of the motor or on a shaft that the motor turns (typically of an optical type, but the encoder can be resistive, capacitive, magnetic, or mechanical) to a decoder circuit that converts the feedback signal to a representative voltage or current value. Then an analog comparator circuit (typically employing comparator type operational amplifiers) compares the value obtained from the position encoder against the position value (also in analog form as a voltage or current value) sent to the other comparator input by the end user.

Fourth, the analog comparator's output (which will be zero or a relative positive or negative voltage) will be either directly used to drive the analog power output circuit, increasing or decreasing the power drive signal commutating the motor to adjust the velocity (in simple speed controller) or it will be sent to a more complex analog circuit (typically comprised of operational amplifiers and analog filters) that performs a PID function to adjust the velocity of the motor not just to set the speed, but to adjust the position and/or acceleration of the motor. This type of analog motor controller employs operational amplifiers and filters that perform the PID functions. In sophisticated analog motion controllers, there are numerous analog filter circuits that correct for noise, motor operating limits, and the gain values given to various PID loop values.

The foregoing are meant to be examples of typical digital and analog motor controllers. Some of the specific aspects may vary from system to system, such as the combination of one or more of the electronic hardware circuits onto one circuit board and whether that circuit board is a stand-alone design or in the form of a personal computer plug-in card. In some variations, there are digital circuits mixed with analog circuits.

The existing state of the art in digital motor control systems is prone to a number of serious drawbacks. To date, digital systems have relied on software intensive microprocessors for control of the desired motor position, velocity, and/or acceleration value at any particular moment. These have inherent errors due to latency, inaccuracies caused by any circuits that convert between digital and analog representations of values (e.g., D/A and A/D converters), and the use of analog filter circuits to provide compensation for noise, motor operating characteristics, environmental conditions, etc.

The existing state of the art in analog motor control systems is also prone to a number of serious drawbacks. For example, in systems that employ analog circuits for compensation, these analog circuits are very sensitive to the “tuning” of the various analog filters they contain to compensate for errors. De-tuning can occur from a variety of causes such as component ageing, environmental changes, increases or decreases in motor friction, changes in load inertia, etc. If one or more of these filters goes out of “tune”, there is no electronic means inherent in such motor control systems that enables self-correction. As a result, as a system de-tunes from optimal values, the values used in the PID computation become increasingly inaccurate and the system is no longer able to accurately know or predict the future position of the motor. When this happens, the motor will malfunction in a variety of ways, including stalling, undershoot or overshoot, unwanted vibration and noise, and loss of known position. As a result, current art generally requires a skilled technician to manually turn variable resistors and/or variable capacitors on the controller's circuit board to attempt to optimize tuning.

In addition to the errors that build up over a relatively short time in such digital and analog motor control systems, there are often physical installation issues involving the signal cabling, power supply cabling, and the encoder feedback cabling. Because these control systems are based upon sensitive measurements of small and easily affected voltages, all wiring has to be short and the power supplies typically have to be much more expensive “split rail” designs that provide sizeable amounts of plus and minus voltage and current with very little noise. All of these factors add to the cost and make such motor control systems more expensive to manufacture, install, and maintain.

### 3. BRIEF SUMMARY OF THE INVENTION

According to one aspect of the invention, there is provided a controller for controlling an electric motor comprising an input for receiving the value of a parameter for said motor, said parameter comprising any one of position, velocity, acceleration and rate of change of acceleration; a digital circuit for determining an error correction value based on the value of said parameter received at said input and a value indicative of a measured value of said parameter, and generating means for generating a drive signal for driving said motor based on said error correction value.

According to another aspect of the invention, there is provided an error correction unit for a controller for controlling an electric motor, comprising a digital circuit for receiving a digital input value indicative of the value of a parameter for said motor and a second digital value indicative of a measured value of said parameter, said digital circuit being adapted to operate on said digital values to generate a digital error correction value for controlling said motor.

According to another aspect of the invention, there is provided a generator for generating one or more drive signals for driving an electric motor, comprising a circuit for receiving a control signal and for generating one or more pulsed drive signals based on said control signal.

According to another aspect of the invention, there is provided a method of configuring a controller for a motor, the controller comprising a position input translator, a detector for measuring the position of an output drive of said motor, and a generator for generating a drive signal for driving said motor, the method comprising the steps of: (a) inputting a predetermined position input value to said position input translator; (b) providing an open loop value to said generator for causing said output drive to move to a position corresponding to said predetermined position input value, as measured by said detector; and (c) configuring said position input translator based on said open loop value.

Embodiments of the invention provide a controller for controlling a motor, in which the controller is implemented by means of an all digital circuit, PID loop, numerical motor controller. “Motor” includes, but is not limited to, DC galvanometers, DC brushless motors, DC brush type motors (2 or 3 pole), DC three pole servo motors, DC rotary solenoids, and AC servo motors. Embodiments of the invention do not contain a microprocessor or utilize any software and do not contain any analog circuits. Typically, embodiments of the invention can be implemented in a single, high density logic semiconductor such as an ASIC, FPGA, or CPLD.

Embodiments of the invention comprise combinatorial and state logic circuits comprising any one or more of five primary elements: (a) a position input translator; (b) a digital error correction unit; (c) a digital adder; (d) a digital feedback decoder and counter; and (e) a digital drive signal generator required to commutate the particular type of motor used (e.g., a digital PWM (Pulse Width Modulation) signal generator). These elements operate to achieve such motor driving purposes.

Compared to existing motor control systems with comparable functions which are based largely upon microprocessors, software, and/or analog circuits, embodiments of the controller can be much lower in cost, can have equal or greater accuracy, can have significantly reduced latency between user command and motor function, can be more reliable, and can have auto tuning capability to optimize the performance of the controller for the particular motor used.

Embodiments of the invention utilize a novel digital design concept that eliminates most of the troublesome aspects of the present state of the art of digital and analog motor control systems that employ software and/or analog circuits to perform the PID functions. Unlike other such control systems, embodiments of the controller are entirely based upon digital circuitry that does not employ software or microprocessors to operate. In particular, the all digital design using only combinatorial and state logic has the following advantages: (1) eliminates analog filters that frequently go out of tune and cause malfunction or failure; (2) uses a more accurate digital comparator in place of software and/or analog amplifiers; and (3) is able to employ much higher resolution motor position encoders; (4) the latency resulting from the use of software for performing PID calculations is eliminated; (5) the effects of noise throughout the motor control system is minimized; (6) the overall control of a motor is simplified by allowing direct interface to the end user, thereby eliminating the need for digital to analog conversion circuitry; and (7) allows the use of a variety of different motor types. The end result is a more robust and versatile motor control system at a significantly reduced cost.

Embodiments of the controller comprise a digital numerical engine having five main parts that together perform all of the operations necessary to receive a position value from a system operator and to translate that position value into the drive signals necessary to make a particular motor go to that position at a velocity and with an acceleration that is optimal for the particular installation.

The first part of the Numerical Engine is the Position Input Translator. This circuit receives control inputs and output signals to the system user interface (typically a personal computer). This circuit translates the position input into an open loop control value. This translation can be accomplished in a variety of ways. For simple applications, one or more adder and multiplier circuits, with pre-loaded coefficients) would suffice. In a preferred embodiment, a look-up table is used. In cases where a look-up table would be undesirably large, a hybrid approach could be utilized wherein adder and/or multiplier circuits would interpolate between periodically spaced values stored in a look-up table. There are other circuits that could be devised to accomplish a specific subset or range of operation for a particular type of motor operation (e.g., only partial motor rotation).

The second part of the Numerical Engine is an Adder circuit which performs a summation of the position value received from the look-up table and adds (or subtracts) a correction value from the third digital circuit, which is the Error Correction unit.

The third part of the Numerical Engine is an Error Correction circuit which receives inputs from the system Position Input, the system Control I/O, and from the Encoder Feedback Decoder and Counter circuit. The Error Correction circuit compares the desired position (sent by the system user) with the actual position detected by the Feedback Decoder and Counter circuit, and creates an error correction value. In turn, this error correction value is sent to the Adder circuit which makes the necessary correction on the original position value entered by the system user.

Once a corrected position value is obtained from the Adder, it is sent to the fifth part of the Numerical Engine which is the Motor Commutation Engine that translates this position value into the logic level drive signals necessary to drive a power drive circuit appropriate for the particular type of motor.

An object of embodiments of the invention is to provide an apparatus and method to control a motor's position, velocity and acceleration with very high accuracy and repeatability. Further details of embodiments of the invention will be described in the following portions of the specification, wherein the description is for the purpose of fully disclosing preferred embodiments of the invention without placing any limitations thereon, and are for illustrative purposes only.

### 4. BRIEF DESCRIPTION OF THE DRAWINGS

Examples of embodiments of the invention will now be described with reference to the following drawings, in which:

FIG. 1 is a diagrammatic representation of an embodiment of the overall digital motor control system.

FIG. 2 is a diagrammatic representation of an embodiment of the Numerical Engine 1.

FIG. 2a is a diagrammatic representation of an embodiment of the Position Input Translator 9.

FIG. 2b is a diagrammatic representation of an embodiment of the Feedback Decoder and Counter 16.

FIG. 2c is a diagrammatic representation of an embodiment of the Error Correction Unit 11.

FIG. 3 is a diagrammatic representation of an embodiment of the Motor Commutation Engine 17.

FIG. 4 is a diagrammatic representation of waveforms generated by an embodiment of the Comparator 22.

FIG. 5 is a diagrammatic representation of an embodiment of the Motor Commutation Logic Array 23.

FIG. 6 is a diagrammatic representation showing a preferred embodiment of pulse width logic in the Motor Commutation Engine 17 suitable for driving motors as shown in FIGS. 12a, 12b, 12c, 12d, 12e, or 12f.

FIG. 7 is a diagrammatic representation showing a preferred embodiment of the pulse width logic in the Motor Commutation Engine 17 suitable for driving motors as shown in FIGS. 12b, 12d, 12e, or 12f.

FIG. 8a is a diagrammatic representation of waveforms generated by an embodiment of the Motor Commutation Engine for use in driving the motors as shown in FIG. 6.

FIG. 8b is a diagrammatic representation of waveforms generated by an embodiment of the Motor Commutation Engine for use in driving the motors as shown in FIG. 7.

FIG. 9 is a diagrammatic representation of full cycle commutation of waveforms for driving the motor shown in FIG. 12e.

FIG. 10a is a diagrammatic representation of an embodiment of the Power Control Circuit for a two pole motor.

FIG. 10b is a diagrammatic representation of an embodiment of the Power Control Circuit for a three pole motor.

FIG. 11 is a diagrammatic representation of an embodiment of a Motor Drive used in the Power Control Circuit.

FIG. 12a is a diagrammatic representation of the connections for a single coil motor using a two pole driver circuit.

FIG. 12b is a diagrammatic representation of the connections for a dual coil motor using a two pole driver circuit.

FIG. 12c is a diagrammatic representation of the connections for a dual coil motor using a two pole driver circuit.

FIG. 12d is a diagrammatic representation of the connections for a dual coil motor, with a center tap, using a three pole driver circuit.

FIG. 12e is a diagrammatic representation of the connections for a three coil motor using a three pole driver circuit.

FIG. 12f is a diagrammatic representation of the connections for a three coil, “wye-connected” motor using a three pole driver circuit.

### 5. DESCRIPTION OF EMBODIMENTS

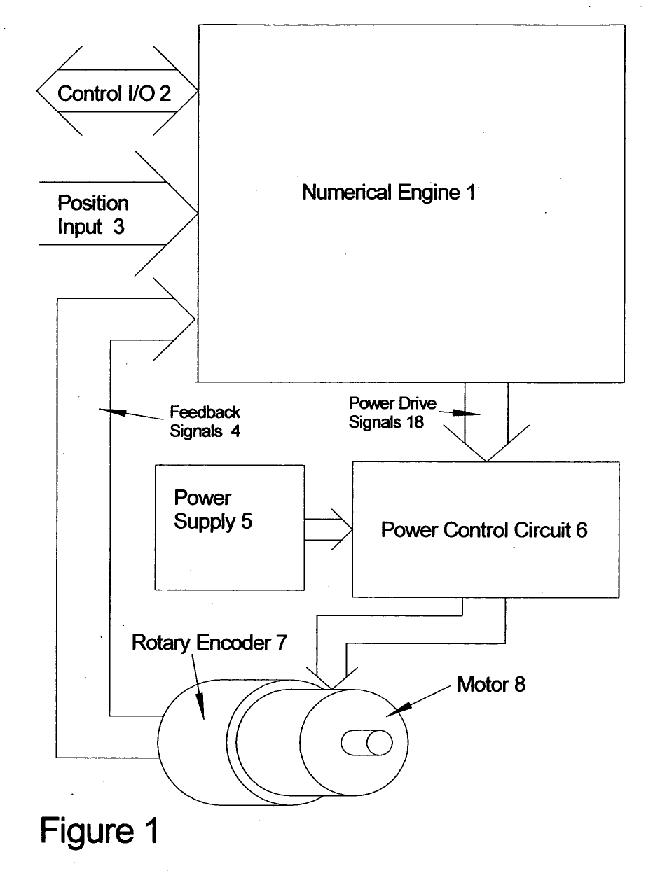

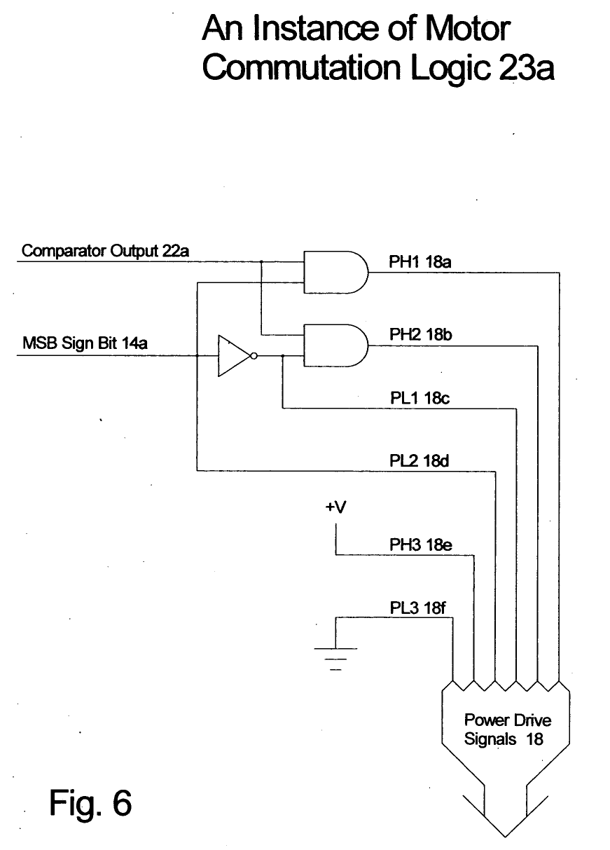

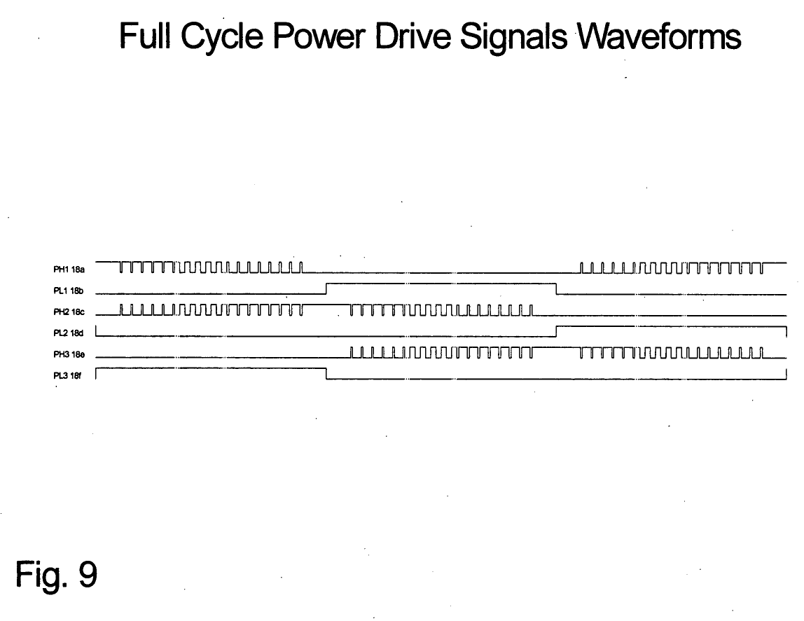

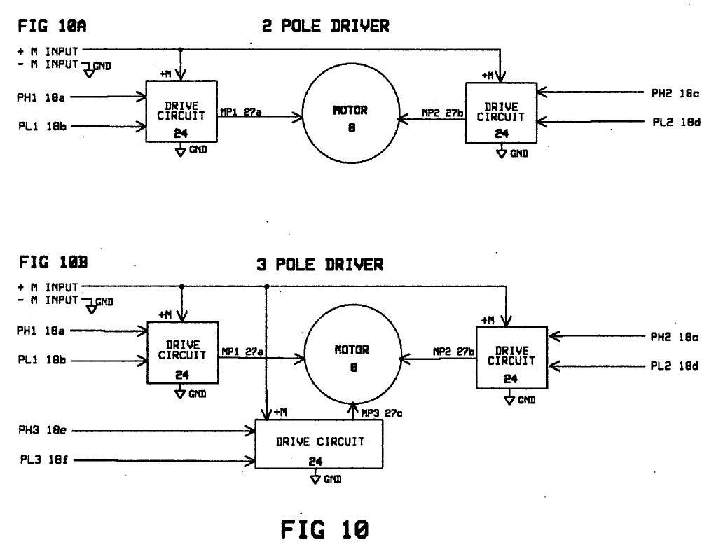

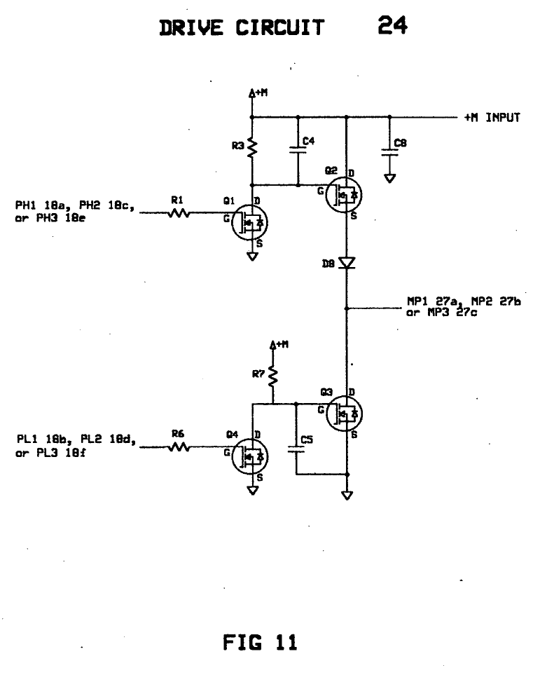

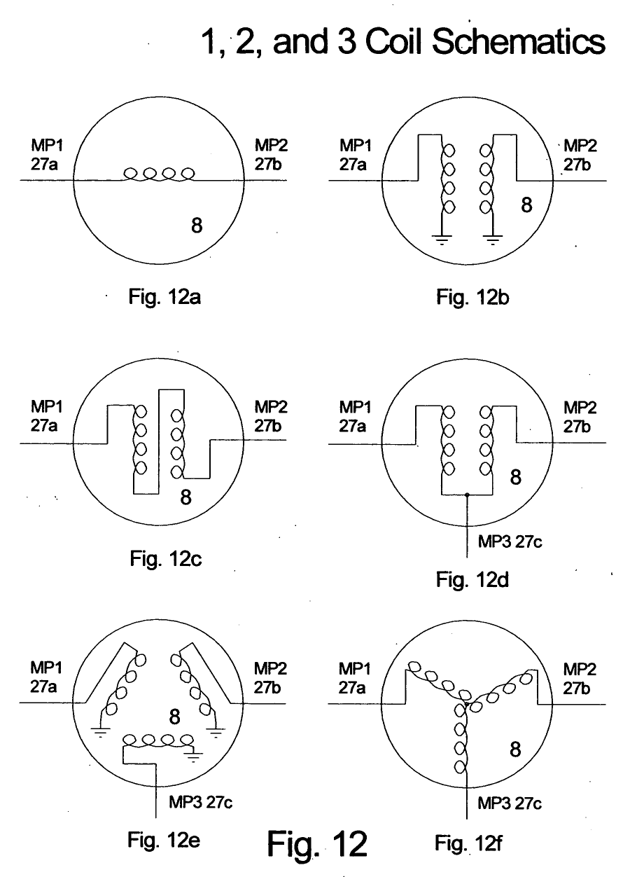

Referring more specifically to the drawings, for illustrative purposes the present invention is embodied in the apparatus generally shown in FIG. 1 through FIG. 12e. While the examples given in FIGS. 6, 7, and 8 are for only a single phase of motor rotation (typically 60 degrees for a three pole motor or 90 degrees for a two pole motor), one skilled in the art would appreciate that similar Motor Commutation Logic could be used to generated waveforms for full rotation of any motor. FIG. 9 gives an example of full rotation of the motor as described in FIG. 12e. It will be appreciated that the apparatus may further vary as to configuration and as to details of the parts, and that the method may vary as to details and the order of the steps, without departing from the basic concepts as disclosed herein.

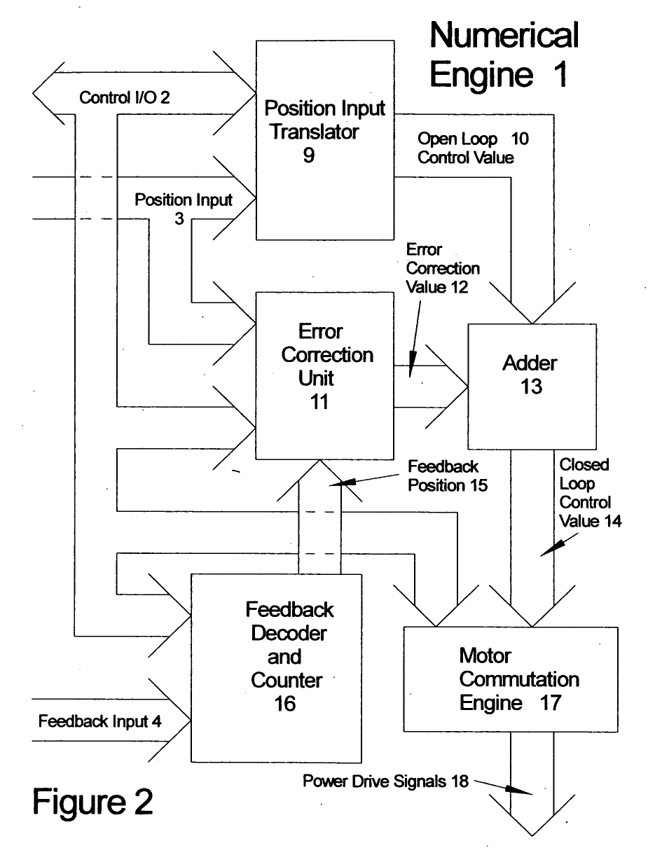

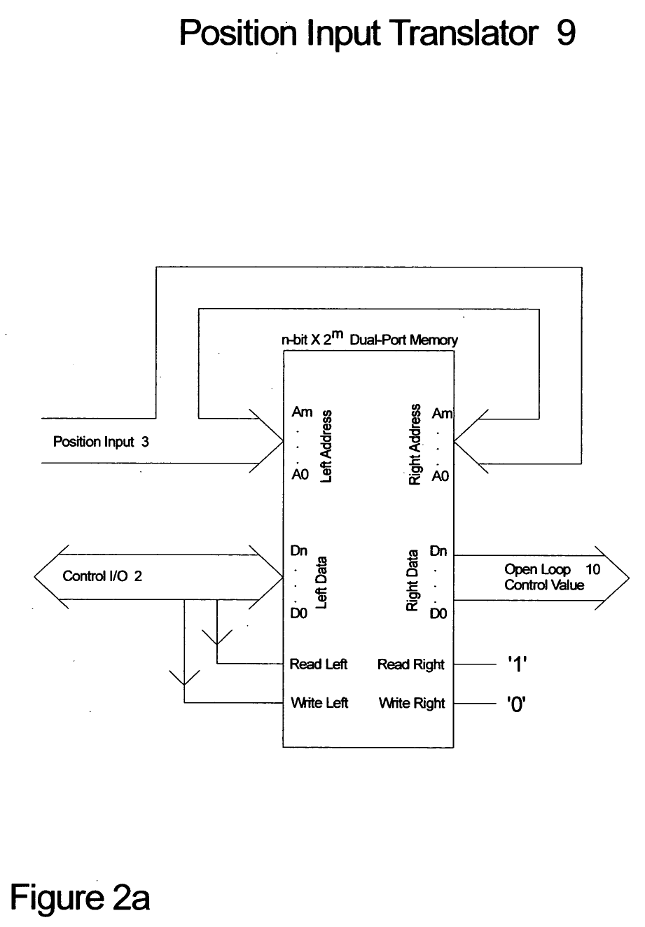

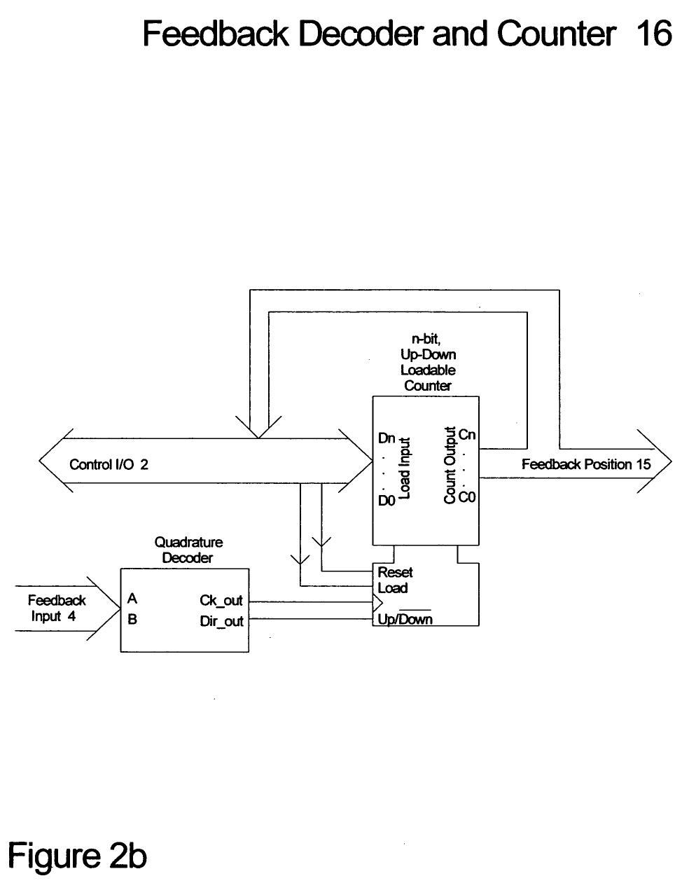

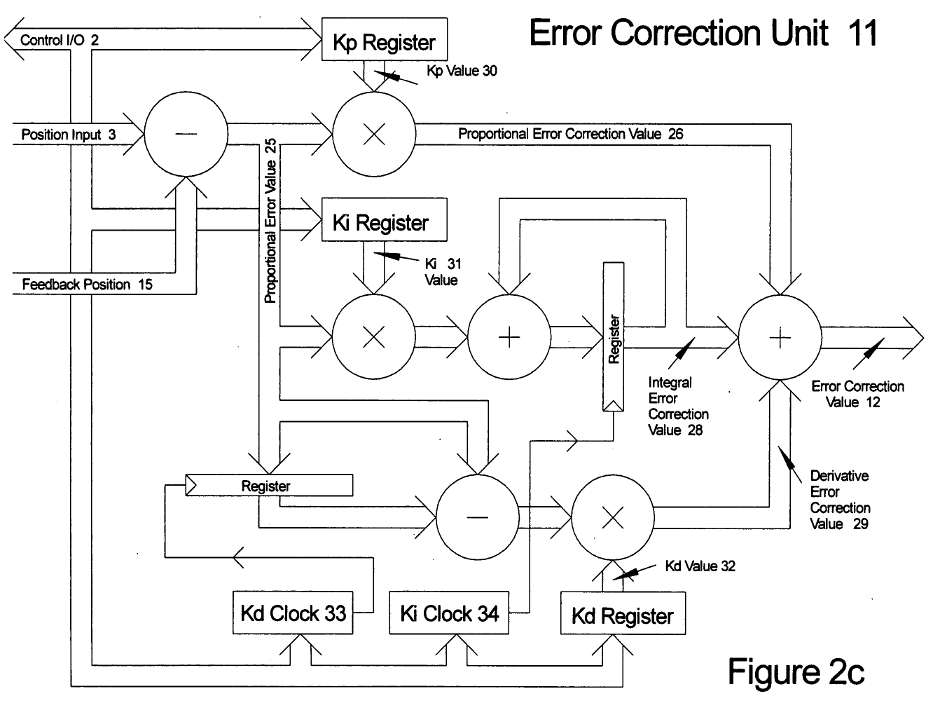

Referring to FIGS. 1 and 2, the digital control system for operating one or more motors is set out diagrammatically. The system works by receiving a Position Input 3 value from a external source (such as a personal computer), such Position Input 3 value representing the desired angular motor position. In response to Position Input 3 and feedback information from Motor 8, the system then outputs the required Power Drive Signals 18 to a Motor 8 by means of the Power Control Circuit 6 which translates the logic level Power Drive Signals 18 to voltage and current levels required by the particular type of Motor 8 used to cause such Motor 8 to move to the desired angular position. In addition to the Position Input 3 value, the system also is capable of receiving and transmitting Command I/O 2 commands for specific purposes, which may include any one or more of commands to optimize the error correction values in the Error Correction Unit 11, to change the coefficients or values in the Position Input Translator 9, to receive Motor 8 position information from the Feedback Decoder and Counter 16, and to acknowledge the status of the system. Such Control I/O 2 signals enable the controller to undergo automated electronic tuning that optimizes the accuracy and speed of the angular positioning of the particular Motor 8. The purpose of controlling the desired angular position of Motor 8 with a high degree of speed and accuracy is to maximize the position accuracy and the accuracy of control of velocity and acceleration.

Referring to FIG. 2, the operation of the system begins with pre-determined coefficients or values in the Position Input Translator 9, or the loading of pre-determined coefficients or values into the Position Input Translator 9 if volatile memory is used for Position Input Translator 9. Simultaneously, a value (initially zero) is inputted to Position Input 3, which is sent to the Position Input Translator 9 and the Error Correction Unit 11. Then, the Feedback Decoder and Counter 16 is reset to zero, or to the number representing the actual current position of the Rotary Encoder 7, if it is capable of providing absolute (not relative) position information, to establish a starting position. FIG. 2b shows an embodiment of the Feedback Decoder and Counter comprised of a quadrature decoder (for use where, for instance, the Rotary Encoder 7 provides a standard quadrature output) and a loadable, resettable up-down counter. Next, the gain constants in the Error Correction Unit 11 can be loaded or changed, as desired, to affect the response of the Error Correction Unit 11 to the Position Input 3 value and the Feedback Position 15 value. The Error Correction Unit 11 would then be re-enabled. This would complete the initialization process. This initialization process, or portions thereof, can be repeated as necessary to obtain the desired starting Motor 8 angular position.

In one example, Position Input 3 value is a numerical representation of an angular position scaled according to the resolution of the Rotary Encoder 7. For example, if the Rotary Encoder 7 has a resolution of 36,000 counts (15+ bits) per revolution, the number of counts per degree is equal to 36,000 divided by 360. In this example, that would be 100 counts per degree. Thus, the Position Input 3 value would be a number equal to the desired angular position (from a designated physical zero or reference point) multiplied by 100. If an angular position of 4.28 degrees is desired, the Position Input 3 value would be 428. The value of 428 then, in this case, would also be an input of both Position Input Translator 9 and Error Correction Unit 11.

After initialization, typical system operation begins with the end user inputting Position Input 3 value. The Position Input Translator 9 translates the Position Input 3 value into an Open Loop Control Value 10 which is a representation of the amount of force that will be required to move to the position indicated by the Position Input 3 value, such representation typically in the form of an rms voltage that will generate enough motor movement to reach the desired position. The amount of the force required to actualize a particular movement will, of course, depend upon a variety of factors such as the particular motor, drive circuit, and load to be moved. If, by way of example, the Position Input Translator 9 were comprised of a look-up table implemented with a dual-port memory (as shown in FIG. 2a), the size of which would be based upon the number of possible Position Input 3 values as determined by Rotary Encoder 7 resolution over the desired range of motion, this would be done by taking the Open Loop Control Value 10 stored in the look-up table at the location equal to the Position Input 3 value (using the above example, the value in the look-up table at address location 428), and sending the Open Loop Control Value 10 to the Adder 13. The initial values in the look-up table in the Position Input Translator would have been determined by a preliminary model (or experimental testing) of the motor, drive circuit, and load to be operated. After the initial values are tried, the auto tuning method described below can then be employed to optimize the values in the look-up table.

Position Input 3 value, as described above, is also simultaneously sent to the Error Correction Unit 11. There, it is utilized (along with the Feedback Position 15) as a variable in the computation of the Error Correction Value 12. While other means of computing an Error Correction Value 12 could be used without departing from the scope of this invention, the preferred embodiment utilizes PID control, the principles of which are familiar to one skilled in the art. FIG. 2c is a diagrammatic representation of an embodiment of the Error Correction Unit 11 comprising circuitry for PID control. In this example, Feedback Position 15 is subtracted from Position Input 2 to yield the Error Value 25. Proportional Error Value 25 is then used by three separate circuits to evaluate the Proportional Error Correction Value 26, the Integral Error Correction Value 28, and the Differential Error Correction Value 29. These three values are then summed to obtain the Error Correction Value 12.

The following is an example of computing the Error Correction Value 12 using PID control and is represented by the formula:
Error Correction Value 12=(P*Kp)+(I*Ki)−+(D*Kd)

Where the subject variables have the following definitions:

P=the Proportional Error Value 25 which is Position Input 3 value, minus Feedback Position 15 value.

I=the integral of the Proportional Error Value 25, this can be obtained as the value from an integrating summing register, the value of which increases or decreases in response to the magnitude of the Proportional Error Value 25 over time. When the Proportional Error Value 25 is zero, the value of the integrating register will remain unchanged.

D=the derivative of the Proportional Error Value 25. It represents the rate of change of the Proportional Error Value 25, and can be obtained as the difference between the present value of the Proportional Error Value 25 (FIG. 2c) and the value at a previous time interval, such value at a previous time interval being stored, by way of example, in a register of suitable width and clocked regularly at the desired time interval.

Kp (represented as the Kp Value 30 in FIG. 2c) is the gain constant of the Proportional Error Correction Value 26. It can be determined manually by the end user or automatically by electronic tuning (as described below).

Ki is the gain constant of the integral Error Correction Value 28 (FIG. 2c). In the preferred embodiment, it is a combination of a value (represented in FIG. 2c as Ki Value 30) to be multiplied with the Proportional Error Value 25, and the clock rate of an integrating register.

Kd is the gain constant of the Derivative Error Correction Value 29. In the preferred embodiment it is implemented as a combination of a value (represented in FIG. 2c as Kd Value 32) to be multiplied with the proportional Error Value 25, and the clock rate of a delay register.

The Proportional Error Correction Value 26 is the Error Value 25 multiplied by the proportional gain constant Kp Value 30 as set via Control I/O 2. The Integral Error Correction Value 28 is the sum over time of the Error Value 25 multiplied by the integral gain constant Ki Value 31. The magnitude of the Integral Error Correction Value 28 is also affected by the rate of summation, as set by the Ki Clock 34 rate, which is set via Control I/O 2. The Derivative Error Correction Value 29 is the result of multiplying the derivative gain constant Kd Value 32 (as set by Control I/O 2) by the difference of the then current Proportional Error Value 25 and the Proportional Error Value 25 registered at a prior time as determined by the Kd Clock 33 rate (as set by Control I/O 2).

The Adder 13 comprises or consists of logic which sums the Open Loop Control Value 10 and the Error Correction Value 12 to yield the Closed Loop Control Value 14. The Closed Loop Control Value 14 is sent to Commutation Control Engine 17. One skilled in the art can appreciate that the Commutation Control Engine 17 could be replaced with a digital to analog converter (DAC) and a conventional servo amplifier to form a hybrid digital/analog version of the invention. This in not the preferred embodiment, but is within the scope of the invention claimed by applicant.

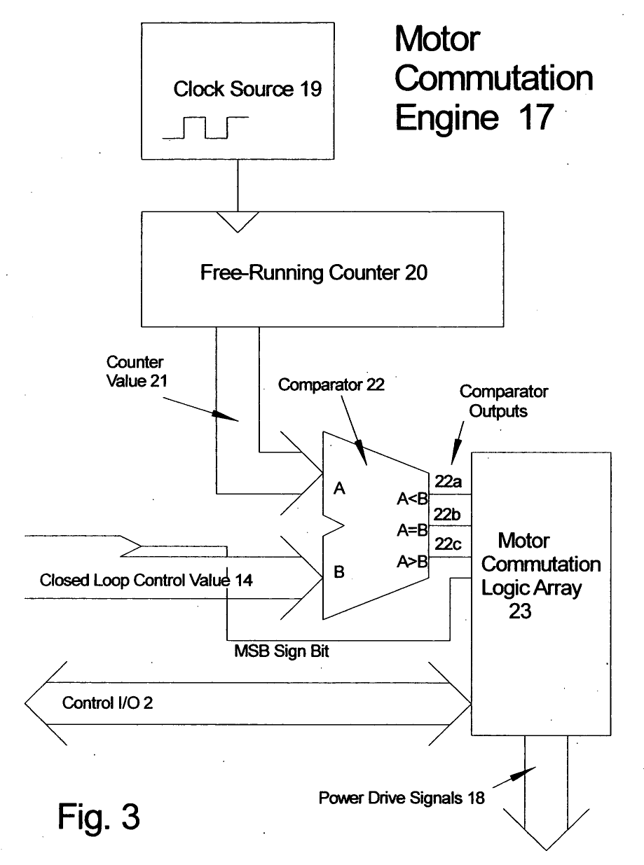

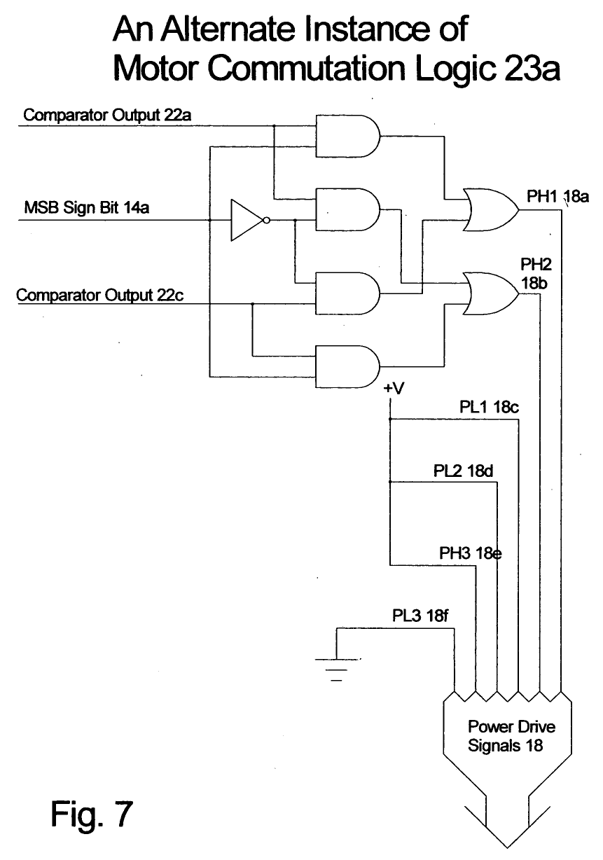

Referring to FIG. 3, the Commutation Control Engine 17 constantly compares the Closed Loop Control Value 14 with a Free Running Value 21 generated by a Free Running Counter 20. The Free Running Counter 20 is incremented periodically by Clock Source 19 which preferably has a frequency sufficient to enable the count in Free Running Counter 20 to roll over at a speed sufficient to enable the Power Drive Signals 18 to properly operate the Motor 8. This is typically in the range of several kilohertz or greater. The particular circuit configuration of Commutation Control Engine 17, as discussed below (see e.g., FIGS. 6 and 7), can be reconfigured by a Control I/O 2 command to produce different Power Drive Signals 18.

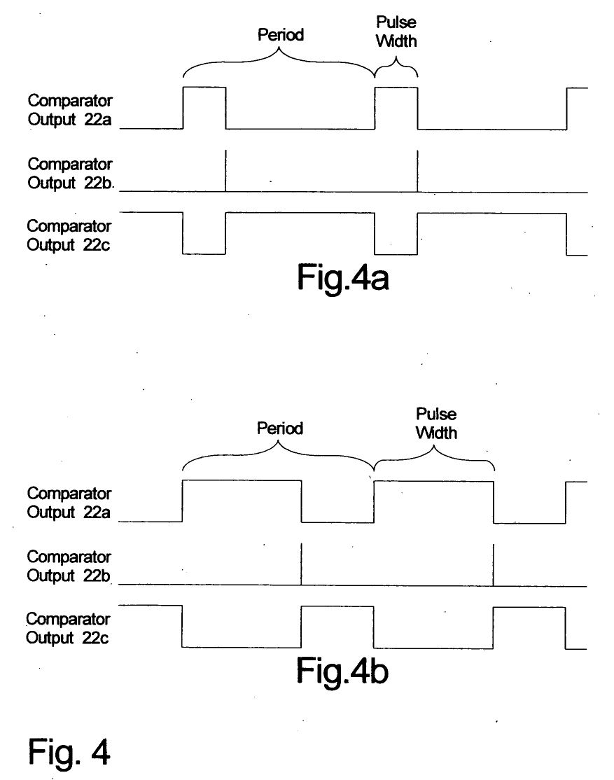

The Comparator 22 compares the Free Running Counter Value 21 against the Closed Loop Control Value 14. If the Free Running Counter Value 21 is greater than the Closed Loop Control Value 14, then Comparator Output 22c is asserted. If the Free Running Counter Value 21 is equal to the Closed Loop Control Value 14, then Comparator Output 22b is asserted. If the Free Running Counter Value 21 is less than the Closed Loop Control Value 14, then Comparator Output 22a is asserted. The result of the foregoing operation of Comparator 22 is a square wave of various duty cycles. Examples of the square waves and the duty cycles that are outputted by the Comparator 22 are shown in FIG. 4. For example, if Free Running Counter 21 is a 10 bit counter (it could be larger or smaller as desired) and the Closed Loop Control Value 14 is 225, then a waveform such as shown in FIG. 4a would result. If the Closed Loop Control Value 14 is 670, then a waveform such as shown in FIG. 4b would result.

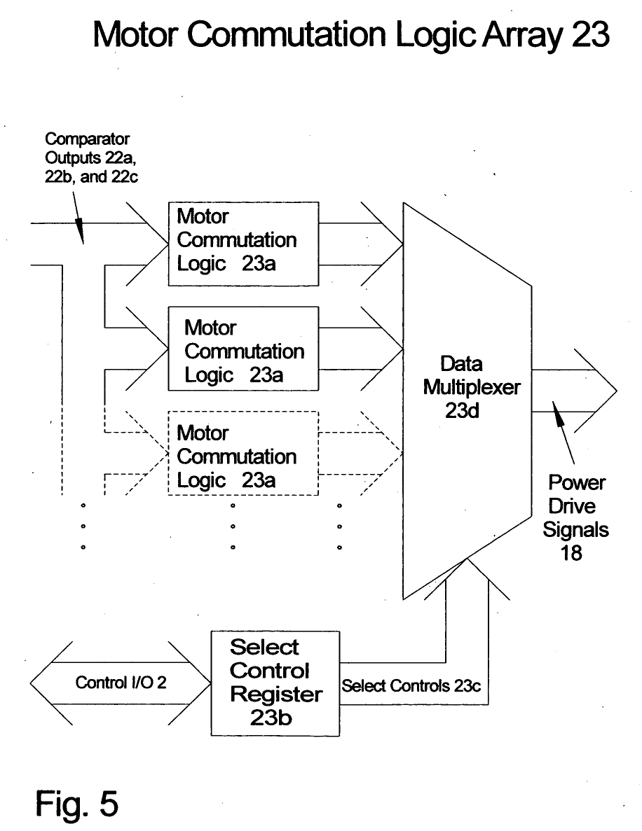

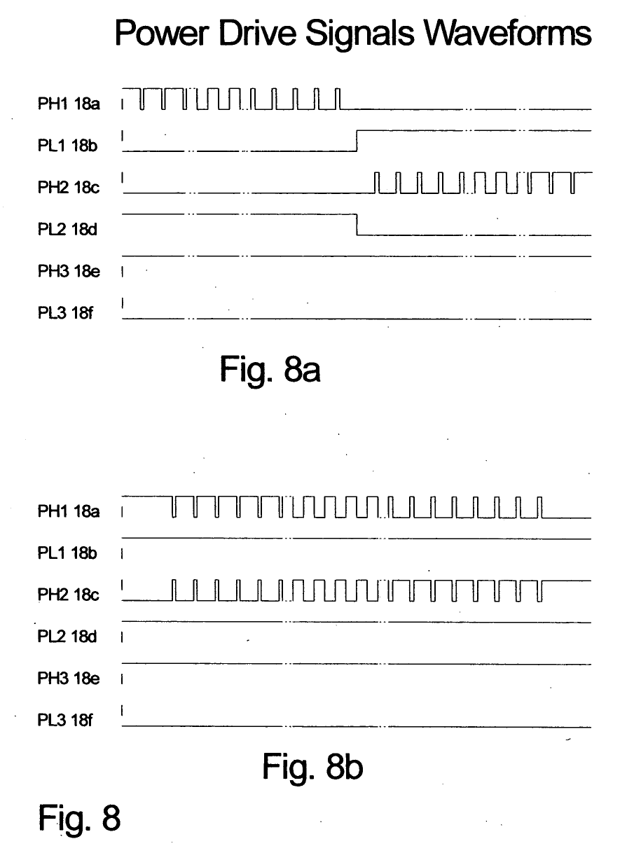

Referring to FIGS. 6 and 7, the Commutation Control Engine 17 can include or consist of different logic circuits to produce different outputs for the Power Drive Signals 18 depending upon what type of Motor 8 is being utilized. An example of the Power Drive Signals 18 used for driving a Motor 8 derived from the Commutation Control Engine 17 is shown in FIG. 8a. These waveforms would be created by the logic in FIG. 6. The waveforms shown in FIG. 8b would be created by the logic in FIG. 7. Determination of which Commutation Logic Circuit 23 would be used with a particular Motor 8 would depend upon the mechanical, electrical, and electromagnetic characteristics of that motor. One of the unique features of embodiments of the invention is this ability to create different commutation signals as may be required to optimize the performance of any particular Motor 8 that is utilized. This feature of the invention permits the control of any of a wide variety of different motors. This can be achieved as shown in FIG. 5 by sending a command via Control I/O 2 to a Select Control Register 23b that will select which amongst the possible Commutation Logic Circuits 23 is utilized for a particular type Motor 8. It should be noted that while three different Commutation Logic Circuits 23a are shown in FIG. 5, a person skilled in the art could implement any number of desired Commutation Logic Circuits 23. It can also be noted that if only one type of Motor 8 is going to be used, then the Select Control Register 23b and the Data Multiplexer 23d could be omitted, and only a single Commutation Logic 23a circuit would be included.

Auto Tuning Capability

As mentioned above, with an appropriate command sequence sent to the Numerical Engine 1 via Control I/O 2, the digital control system according to embodiments of the invention can be automatically tuned to provide optimum speed and accuracy for a particular Motor 8. This would involve the following process. [Note: Although the following description refers to the case where the Position Input Translator 9 comprises a look-up table, one skilled in the art can appreciate that a similar procedure would be used for the case of coefficients for the Position Input translator comprised of adder and multiplier circuits, or for the case of coefficients and look-up table values for a hybrid circuit. For Example, in some embodiments, coefficients could be determined by collecting data for each position or a number of different positions, determining a mathematical relationship between input value and open loop control value, and then implementing the derived function by digital, i.e. logic circuitry.

The first step is to disable the Error Correction Unit 11 (i.e., force the Error Correction Value 12 to zero) by a command via Control I/O 2. Then, the values in a look-up table in the Position Input Translator would be set to zero (or to values obtained from a prior tuning). The desired Commutation Logic 23a circuit is selected from the possible choices in the Commutation Control Engine 17. Next, the Position Input 3 value would be set to one and the value (i.e. the open loop control value) of the first position in the look-up table would be incremented until the Feedback Position 15 equals one.

The incrementing of the Position Input 3 values in the look-up table is done from a user interface connected to the Control I/O 2 and can be accomplished by a variety of methods including manual entry of a value for each Position Input 3 value, or by a variety of semi-automated or full-automated external programs or digital logic that enters each Position Input 3 value. Initial values could be zeros or values that are based upon a model of the motor, drive circuit, and load, or values that are based upon empirical data that are the results of experimental testing. The incrementing of the Position Input 3 value location in a look-up table, for example, could be done by direct addressing or by the use of an auto-incrementing counter. The values representing the motor position as detected by the Feedback Decoder and Counter 16 are sent back to the user interface (of whatever design) by way of the Control I/O 2 bus. The external user interface, by manual, semi-automatic, or fully automatic means finds the Open Loop 10 value that best achieves the originally desired motor position. Then the Position Input 3 value would be set to two, and the second location in the look-up table would be incremented until the Feedback Position 15 equals two. This process would generally be repeated for all locations in the look-up table until each such location is loaded with a value that causes the Feedback Position 15 to be equal to the Position Input 3 value for each location in the look-up table.

Even further optimization to correct for hysteresis and friction in the Motor 8 may be accomplished by externally recording all of the values stored in the look-up table during the above described ascending value determination, and averaging such values with new values obtained from doing a descending value determination. Since friction values tend to be unpredictable, repeated iterations of the foregoing process can provide a more optimized set of values for the look-up table. In embodiments, the procedure may be performed in either direction, i.e. with ascending values first followed by descending values, or vice versa. Furthermore, for some motor types, values may be determined in a non-sequential, or random order, if desired.

After all values for each location in the look-up table have been established, then the Error Correction Unit 11 can be optimized. The first gain constant that should be initialized is Kp Value 30. An initial value for Kp Value 30 could be a function of the possible magnitude Open Loop Control Value 10. For example, if the open Loop Control Value 10 is a 16 bit value, then Kp Value 30 would not be expected to be larger than 8 bits, and four bits (2⁴) is a likely starting value (alternatively, an initial value of one could be used). The initial value for Ki Value 31 should be zero. A reasonable initial value for Kd Value 32 would be zero. To optimize Kp Value 30, Ki Value 31, and Kd Value 32, the Position Input 3 value can be changed while the Feedback Position 15 value is monitored via Control I/O 2 from the Feedback Decoder and Counter 16. When a change in Position Input 3 value causes Feedback Position 15 to change, the response time, settling time, overshoot, and final accuracy can be recorded. Then, small changes would be made to Kp Value 30, Ki Value 31, and Kd Value 32 and the monitoring of Feedback Position 15 would reveal whether the response time, settling time, overshoot, and final accuracy are improved. This process would be repeated until the best response time, settling time, overshoot, and final accuracy are found, and then the corresponding values of Kp Value 30, Ki Value 31, and Kd Value 32 would be stored in the Error Correction Unit 11. Depending upon the particular Motor 8 used and desired performance specifications, this process may be done once upon initial system setup and/or it can be done as often as desired to correct for changes in the operating characteristics of the Motor 8 and/or its operating environment. For certain applications, all tuning could be performed at the time of manufacture, and in this case, the only functions that would be required of the Control I/O 2 would be the power-up initialization of the zero position.

Other aspects and embodiments of the controller comprise any one or more feature(s) disclosed herein in combination with any one or more other feature(s) or a variant or equivalent thereof. In any of the embodiments described herein, any one or more features may be omitted altogether or replaced or substituted by another feature disclosed herein or a variant or equivalent thereof.

Numerous modifications and changes to the embodiments described above will be apparent to those skilled in the art.

1. A controller for controlling an electric motor comprising an input for receiving the value of a parameter for said motor, said parameter comprising any one of position, velocity, acceleration and rate of change of acceleration;
a digital circuit for determining an error correction value based on the value of said parameter received at said input and a value indicative of a measured value of said parameter, and
generating means for generating a drive signal for driving said motor based on said error correction value.

2. A controller as claimed in claim 1, wherein said digital circuit includes a circuit for determining the difference value between said input value and the value indicative of said measured value.

3. A controller as claimed in claim 2, further comprising a digital circuit for determining the product value of said difference value and a predetermined constant.

4. A controller as claimed in claim 3, wherein said predetermined constant comprises a gain constant.

5. A controller as claimed in claim 4, wherein said digital circuit for determining said product value comprises a multiplier circuit.

6. A controller as claimed in any one of claims 2 to 5, wherein said digital circuit comprises an integrator circuit for determining the value of an integral of the difference value.

7. A controller as claimed in claim 6, wherein said integrator circuit includes an integrating summation circuit which increases or decreases over time in response to the difference value.

8. A controller as claimed in claim 6 or 7, wherein said digital circuit further comprises a circuit for multiplying the integral value by a constant.

9. A controller as claimed in claim 8, wherein said constant is the gain constant of the integral value.

10. A controller as claimed in claim 9, wherein said gain constant comprises a clock rate of an integrating summation circuit or a scalar multiplier of an integrator circuit.

11. A controller as claimed in any one of claims 2 to 10, wherein said digital circuit comprises a circuit for determining the value of the derivative of the difference value.

12. A controller as claimed in claim 11, wherein said derivative determining circuit is adapted to determine said derivative from an average of the rate of change of the value indicative of said measured value.

13. A controller as claimed in claim 11, wherein said derivative determining circuit is adapted to determine said derivative from the change of the difference value over a specified interval of time.

14. A controller as claimed in claim 11, 12, or 13, wherein said digital circuit further comprises a circuit for determining the value of the product of said derivative value and a predetermined constant.

15. A controller as claimed in claim 14, wherein said predetermined constant comprises a gain constant of the derivative value.

16. A circuit as claimed in any one of claims 1 to 15, further comprising an adder circuit for adding the error correction value and a value based on the input value for said parameter to provide a closed loop control value.

17. A circuit as claimed in claim 16, further comprising a digital circuit for translating said input value into another value.

18. A controller as claimed in claim 17, wherein said other value comprises an open loop control value.

19. A controller as claimed in claim 18, wherein said value based on the input value for said parameter comprises said open loop control value provided by said translator circuit.

20. A controller as claimed in claim 19, wherein said translator circuit includes a lookup table and/or one or more multiplier circuits and/or one or more adder circuits.

21. A controller as claimed in any preceding claim, wherein said parameter is a position of an output drive of said motor, for example, a rotational position.

22. A controller as claimed in any one of claims 1 to 16, further comprising a translator circuit for translating said input value into another value.

23. A controller as claimed in claim 22, wherein said other value comprises an open loop control value.

24. A controller as claimed in claim 22 or 23, wherein said translator circuit comprises at least one of a lookup table, a multiplier circuit and an adder circuit.

25. A controller as claimed in any preceding claim, wherein said means for generating comprises a circuit for generating a pulsed drive signal.

26. A controller as claimed in claim 25, wherein said circuit comprises a counter for generating numerical values, and a comparator for comparing the counter numerical values with a closed loop numerical values, and for generating a resulting value based on said comparison, said resulting value being for use in generating said drive signal.

27. A controller as claimed in claim 26, further comprising a logic circuit for generating said drive signal based on said resulting value.

28. A controller as claimed in claim 27, wherein said logic circuit is adapted to generate said drive signal based on the value of at least one other parameter.

29. A controller as claimed in claim 27 or 28, further comprising a plurality of logic circuits, each logic circuit being adapted to perform a different logical operation, and a selector for selecting a logic circuit from said plurality of logic circuits for generating said drive signal.

30. A controller as claimed in any preceding claim, wherein said input value is a numerical/digital value.

31. A controller as claimed in any preceding claim, wherein said measured value is a numerical/digital value.

32. A controller as claimed in any preceding claim, wherein said digital circuit comprises circuitry for receiving and processing said input value and said measured value as numerical/digital values.

33. A controller as claimed in claim 32, wherein said digital circuit is adapted to convert said numerical/digital values into a digital/numerical output comprising said error correction value.

34. A controller as claimed in any preceding claim, wherein said digital circuitry consists of or consists substantially of logic circuitry.

35. A controller as claimed in any preceding claim, wherein said digital circuit comprises an interface for receiving one or more parameters for configuring said digital circuit.

36. An error correction unit for a controller for controlling an electric motor, comprising
a digital circuit for receiving a digital input value indicative of the value of a parameter for said motor and a second digital value indicative of a measured value of said parameter,
said digital circuit being adapted to operate on said digital values to generate a digital error correction value for controlling said motor.

37. An error correction unit as claimed in claim 36, wherein said digital circuit includes a circuit for determining the difference value between said input value and the value indicative of said measured value.

38. An error correction unit as claimed in claim 37, comprising a digital circuit for determining the product value of said difference value and a predetermined constant.

39. An error correction unit as claimed in claim 38, wherein said predetermined constant comprises a gain constant.

40. An error correction unit as claimed in claim 39, wherein said digital circuit for determining said product value comprises a multiplier circuit.

41. An error correction unit as claimed in any one of claims 35 to 39, wherein said digital circuit comprises an integrated circuit for determining the value of an integral of the difference value.

42. An error correction unit as claimed in any one of claims 35 to 40, wherein said digital circuit comprises a circuit for determining the value of the time derivative of the difference value.

43. A generator for generating one or more drive signals for driving an electric motor, comprising a circuit for receiving a control signal and for generating one or more pulsed drive signals based on said control signal.

44. A generator as claimed in claim 43, wherein said circuit comprises a counter for generating numerical values, and a comparator for comparing the counter numerical values with numerical values of said control signal, and for generating a resulting value based on said comparison.

45. A generator as claimed in claim 44, further comprising a logic circuit for generating said drive signal based on said resulting value.

46. A generator as claimed in claim 43 or 44, further comprising a plurality of logic circuits, each logic circuit being adapted to perform a different logical operation, and a selector for selecting a logic circuit from said plurality of logic circuits for generating said drive signal.

47. A method of configuring a controller for a motor, the controller comprising a position input translator, a detector for measuring the position of an output drive of said motor, and a generator for generating a drive signal for driving said motor, the method comprising the steps of:
(a) inputting a predetermined position input value to said position input translator;
(b) providing an open loop value to said generator for causing said output drive to move to a position corresponding to said predetermined position input value, as measured by said detector; and
(c) configuring said position input translator based on said open loop value.

48. A method as claimed in claim 47, further comprising repeating steps (a) to (c) for one or more different predetermined position input value(s).

49. A method as claimed in claim 47 or 48, further comprising recording the or a plurality of said predetermined position input value(s) and the respective corresponding open loop value(s).

50. A method as claimed in claim 49, wherein said position input translator comprises a look-up table, and steps of configuring and recording comprise recording said predetermined position input value(s) and said open loop value(s) in said look-up table.

51. A method as claimed in any one of claims 47 to 50, further comprising determining a relationship between said predetermined position input value(s) and said open loop value(s), and configuring said position input translator based on said determined relationship.

52. A method as claimed in any one of claims 47 to 51, comprising inputting a first predetermined position value to said position input translator, providing an open loop value to said generator for causing said output drive to move to a position corresponding to said predetermined position input value, as measured by said detector, providing a second open loop value to said generator for causing said output drive to move to a position which is different to said position corresponding to said first predetermined position input value, inputting said first predetermined position input value to said position input translator, providing a third open loop value to said generator for causing said output drive to return to a position corresponding to said first predetermined input value, as measured by said detector, said output drive being caused to return to said position in the opposite direction to the direction moved between said first and second output values, and configuring said position input translator based on said first and third open loop values.

53. A method as claimed in claim 52, further comprising the step of averaging said first and third open loop values.

54. A method as claimed in any one of claims 47 to 53, comprising repeating steps (a) and (b) for a plurality of successive ascending or descending predetermined position input values, repeating steps (a) and (b) for a plurality of descending or ascending predetermined position input values, and configuring said position input translator based on the open loop values determined from at least one ascending order process and at least one descending order process.

55. A method as claimed in any one of claims 47 to 54, wherein said controller comprises an error correction unit for generating an error correction value, an adder for adding the error correction value to the open loop value from said position input translator, the method further comprising the step of disabling the error correction unit before performing steps (a) to (c), so that the value provided to said adder from said unit is zero.
